(19) United States
(12) Patent Application Publication
(10) Pub. No.: US 2012/0277928 A1
(43) Pub. Date: Nov. 1, 2012

(54) DEVICE AND METHOD FOR REDUCING THE ENERGY CONSUMPTION OF A MACHINE IN THE FIELD OF AUTOMATION ENGINEERING

(75) Inventors: MICHAEL GESCHWILL, Uehlfeld (DE); Andreas Grözinger, Renningen (DE)

(73) Assignee: Siemens Aktiengesellschaft, Munchen (DE)

(21) Appl. No.: 13/278,647

(22) Filed: Oct. 21, 2011

(30) Foreign Application Priority Data
Oct. 22, 2010 (EP) EP 10188547

(51) Int. Cl. G06F 1/26

(52) U.S. Cl. 700/295

(57) ABSTRACT

A device and method for reducing energy consumption of a machine in automation engineering are disclosed. The device includes an operating unit with a display configured to display energy profiles indicating associated conditions activatable by an operator of the machine, and a monitoring unit receiving the energy profiles from the operating unit and monitoring fulfillment of activated conditions and generating for each of the energy profiles a status signal, when all activated conditions of an energy profile are fulfilled. A disconnection unit disconnects at least one energy consuming component of the machine commensurate with the status signal. The energy consumption of a machine in the field of automation engineering can thereby be reduced.

### CROSS-REFERENCES TO RELATED APPLICATIONS

This application claims the priority of European Patent Application, Serial No, EP 10188547, filed Oct. 22, 2010, pursuant to 35 U.S.C. 119(a)-(d), the content of which is incorporated herein by reference in its entirety as if fully set forth herein.

This application is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “DEVICE AND METHOD FOR REDUCING THE ENERGY CONSUMPTION OF A MACHINE IN THE FIELD OF AUTOMATION ENGINEERING”, representative's docket no.: GESCHWILL-2.

### BACKGROUND OF THE INVENTION

The present invention relates to a device and method for reducing the energy consumption of a machine in the field of automation engineering.

The following discussion of related art is provided to assist the reader in understanding the advantages of the invention, and is not to be construed as an admission that this related art is prior art to this invention.

Machines in the field of automation engineering, such as e.g. machine tools, production machines and/or robots, have a very high energy consumption.

Published U.S. Pat. Appl. No. 2010/0026102 A1 discloses a device and a method for reducing the energy consumption of a machine or system, having a deactivation device and a monitoring device. The deactivation device is embodied for providing a deactivation signal in response to a pre-defined deactivation event. The monitoring device is embodied for switching the machine to an energy-saving mode in response to the deactivation signal in accordance with a pre-defined deactivation rule.

It would be desirable and advantageous to provide an improved device and method for reducing the energy consumption of a machine in the field of automation engineering to obviate prior art shortcomings.

### SUMMARY OF THE INVENTION

According to one aspect of the present invention, a. device for reducing energy consumption of a machine in automation engineering includes an operating unit comprising a display configured to display energy profiles indicating associated conditions activatable by an operator of the machine, and a monitoring unit receiving the energy profiles from the operating unit and monitoring fulfillment of activated conditions and generating for each of the energy profiles a status signal, when all activated conditions of an energy profile are fulfilled.

According to another aspect of the present invention, a machine in automation engineering includes a device for reducing energy consumption, with the device having an operating unit comprising a display configured to display energy profiles indicating conditions activatable by an operator of the machine, and a monitoring unit receiving the energy profiles from the operating unit and monitoring the fulfillment of activated conditions and generating for each of the energy profiles a status signal, when all activated conditions of an energy profile are fulfilled.

According to yet another aspect of the present invention, a method for reducing the energy consumption of a machine in the field of automation engineering by energy profiles which have conditions that can be activated in each case, includes the steps of reading in activated conditions of at least one energy profile selected from activatable conditions of the at least one energy profile, and monitoring fulfillment of the activated conditions and generating for each of the at least one energy profile a status signal, when all activated conditions of the at least one energy profile are fulfilled:

By virtue of the invention, it is easy for an operator of the machine to set up energy profiles that are individually adapted to the needs of the operator.

Advantageous developments of the invention are derived from the dependent claims. Advantageous developments of the device are derived in a similar way to the advantageous developments of the method and vice versa.

According to another advantageous feature of the present invention, a disconnection unit can be provided to receive the status signal from the monitoring unit and to disconnect at least one energy consuming component of the machine commensurate with the status signal. The disconnection of an energy consuming component of the machine makes it possible to achieve a significant reduction in the energy consumption of the machine.

According to another advantageous feature of the present invention, a configuration interface can be configured to specify the at least one energy consuming component of the machine will be disconnected according to the status signal. This allows e.g. a manufacturer of the machine easily to specify which energy consuming components of the machine are to be disconnected according to the status signal.

According to another advantageous feature of the present invention, an activatable condition in a particular energy profile can be considered as being fulfilled when a duration, during which all other activated conditions of the particular energy profile are continuously fulfilled, is equal to or exceeds a limit value.

The machine in the field of automation engineering can take the form of a machine tool, a production machine and/or a robot, for example.

According to still another aspect of the present invention, a computer program for reducing energy consumption of a machine in automation engineering includes a program code embodied in a non-transitory medium, wherein the computer program when executed on a computer of the machine causes the machine to read in activated conditions of at least one energy profile selected from activatable conditions of the at least one energy profile, and monitor fulfillment of the activated conditions and generate for each of the at least one energy profile a status signal, when all activated conditions of the at least one energy profile are fulfilled.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a block diagram of a machine in the field of automation engineering, having incorporated therein a device for reducing the energy consumption of the machine in accordance with the present invention; and

FIG. 2 is a schematic illustration of energy profiles.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

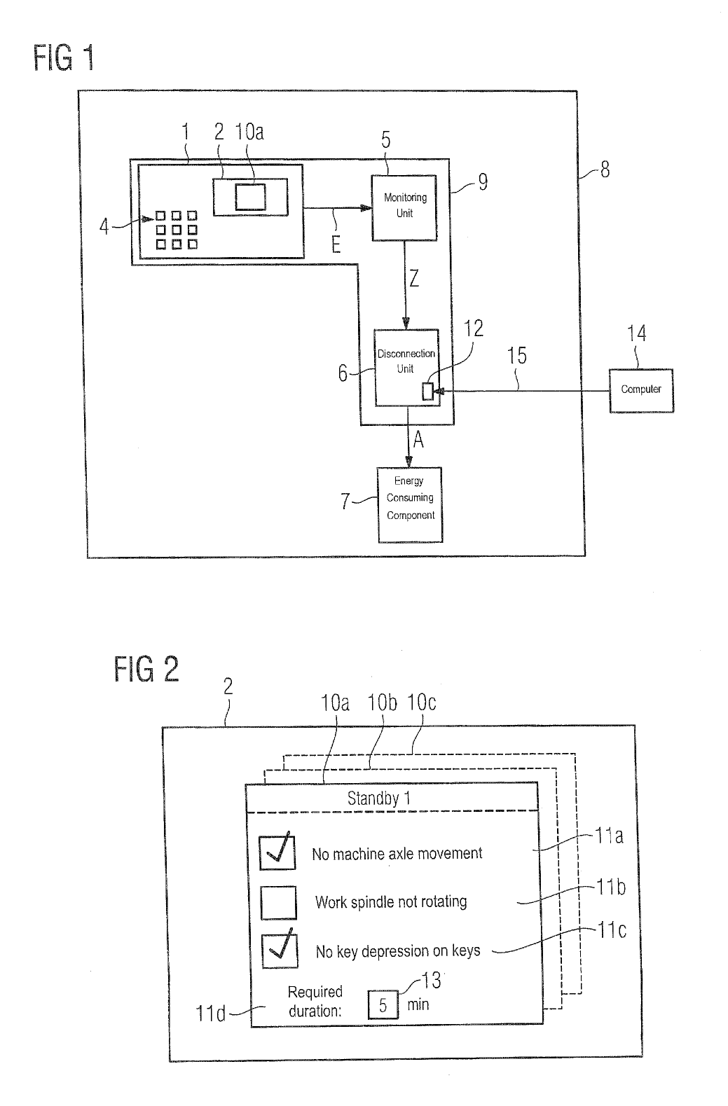

Turning now to the drawing, and in particular to FIG. 1, there is shown a block diagram of a machine 8 in the field of automation engineering, having incorporated therein a device 9 for reducing the energy consumption of the machine in accordance with the present invention. In the context of the exemplary embodiment, the device 9 according to the invention takes the form of a CNC control (computer numerical control) in this case, wherein for the sake of clarity only those elements of the CNC control which are essential to the understanding of the invention are shown in FIG. 1. The device 9 includes an operating unit 1, a monitoring unit 5 and a disconnection unit 6. The monitoring unit 5 and the disconnection unit 6 take the form of executable software code which is executed on one or more processors. The disconnection unit 6 can take the form of an SPC (stored programmable control), for example. The operating unit 1, the monitoring unit 5 and the disconnection unit 6 can be structurally realized in various components of the machine or alternatively in a single component of the machine.

In the context of the exemplary embodiment, the machine 8 is implemented in the form of a machine tool.

The operating unit 1 is used for operating the machine 8. The operation of the machine 8 is performed by an operator in this case. The operating unit 1 includes a display screen 2 on which e.g. energy profiles 10a, 10b and 10c can be displayed, wherein an energy profile 10a is currently displayed on the display screen 2 in FIG. 1. The operating unit 1 also includes input means in the form of keys 4 by way of example. The operator can use the keys 4 to submit inputs for operating the machine.

FIG. 2 shows the display screen 2 and the energy profile 10a in the form of an enlarged schematic view. In this case, the broken line indicates that further energy profiles can be provided in addition to the energy profile 10a, these being denoted by the reference signs 10b and 10c in FIG. 2. The energy profiles feature conditions in each case, wherein the energy profile 10a features the condition 11a “No machine axle movement”, the condition 11b “Work spindle not rotating”, the condition 11c “No key depression on keys” and the condition lid “Required duration” in the context of the exemplary embodiment. The conditions that are displayed for an energy profile can be activated by the operator by means of the operating unit 1, specifically by selecting the conditions using the keys 4 in the case of the conditions 11a, 11b and 11c, for example, and by switching them to active by means of a corresponding key depression, for example. An activated condition in the case of the conditions 11a, 11b and 11c is indicated by a check mark on the display screen 2 in the context of the exemplary embodiment. The condition 11d “Required duration” is activated by entering a number in an entry field 13 that is provided for this purpose. In the context of the exemplary embodiment, the number “5” has been entered and the condition therefore activated. In this case, each energy profile can also be assigned a name by the operator, wherein the energy profile 10a has the name “Standby 1” in the context of the exemplary embodiment. In this case, the conditions 11a and 11c are activated as indicated by corresponding check marks in the context of the exemplary embodiment. Furthermore, the condition 11d is also activated. The condition 11b is not activated, however. The device 9 is therefore designed such that the conditions can be activated by an operator, i.e. the device is so designed as to allow activation of the conditions by an operator. Energy profiles can be created as described above using the device 9, and therefore the device is so designed as to allow the creation of energy profiles. The activated conditions of the energy profiles are read in by the device 9 and in particular by the operating unit 1.

Furthermore, the device 9 monitors the activated conditions of the energy profiles, wherein the device 9 generates a status signal Z, according to the energy profile, in the event that all activated conditions of an energy profile are fulfilled. For this purpose, the energy profiles are transferred to monitoring unit 5 by the operating unit 1, this being indicated by an arrow E in FIG. 1. For every energy profile, the monitoring unit 5 and hence the device 9 monitors the fulfillment of the respective activated conditions in the energy profile and, according to the energy profile, generates a status signal Z in the event that all of the activated conditions of an energy profile are fulfilled. A status signal Z that is associated with the energy profile is therefore generated for every energy profile. In accordance with the status signal Z, the device 9 switches the machine 8 into an energy saving mode that is assigned to the status signal Z. This means that each energy profile is usually assigned an energy saving mode.

For this purpose the status signal Z is transferred to a disconnection unit 6. The disconnection unit 6 effects the disconnection of at least one energy consuming component 7 of the machine 8 in accordance with the status signal Z. The energy consuming components 7 of the machine 8 can take the form of e.g. drives of the machine 8, heaters, pumps, and/or lighting means of the machine. For this purpose, the disconnection unit 6 generates disconnection signals A, which effect a disconnection of the corresponding energy consuming components of the machine. It should be noted at this point that e.g. the operating unit 1 and the device 9 likewise represent energy consuming components of the machine 8, and therefore disconnection of these components of the machine can also be effected via the disconnection unit 6.

The condition 11d is fulfilled when the duration for which all other activated conditions of the energy profile 10a (i.e. the conditions 11a and 11c of the energy profile 10a in the context of the exemplary embodiment) are continuously fulfilled matches a temporal limit value or exceeds said limit value. The limit value is specified as 5 minutes for the energy profile 10a in the context of the exemplary embodiment, meaning that when no machine axle movements of the machine 8 and no key depressions on the keys 4 of the operating unit 1 occur during a time period of 5 minutes in the case of the energy profile 10a, a status signal Z which has been assigned according to the energy profile 10a is generated and transferred to the disconnection unit 6. As a result of this, the disconnection unit 6 generates two disconnection signals, wherein the first disconnection signal effects e.g. a disconnection of the chip conveyor drive of the machine 8 and the second disconnection signal effects a disconnection of a lighting entity that is arranged in the working environment of the machine.

In the context of the exemplary embodiment, the inventive device 9 and in particular the disconnection unit 6 has a configuration interface 12 that is designed for specifying which energy consuming component or energy consuming components of the machine will be disconnected according to the status signal.

Using the configuration interface 12, it is possible for e.g. a manufacturer of the machine 8 to specify which energy consuming components of the machine will be disconnected as a result of which disconnection signal E. By means of the configuration interface 12, it is therefore possible to specify which energy consuming components will be disconnected, according to the energy profile, in the event that all activated conditions of an energy profile are fulfilled. In this case, the configuration interface 12 can be configured e.g. by means of an external arithmetic-logic unit 14 (e.g. personal computer), i.e. an arithmetic-logic unit which is not part of the machine 8, by integrating e.g. a corresponding program into the disconnection unit 6 by means of the external arithmetic-logic unit 14, wherein said program specifies the disconnection of the energy consuming components of the machine depending on the status signal E. This is shown by means of an arrow 15 in FIG. 1.

By means of the energy profiles, the machine 8 can therefore be switched to various energy saving modes, including a complete disconnection of the machine 8.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A device for reducing energy consumption of a machine in automation engineering, comprising:
an operating unit comprising a display configured to display energy profiles indicating associated conditions activatable by an operator of the machine, and
a monitoring unit receiving the energy profiles from the operating unit and monitoring fulfillment of activated conditions and generating for each of the energy profiles a status signal, when all activated conditions of an energy profile are fulfilled.

2. The device of claim 1, further comprising a disconnection unit which receives the status signal from the monitoring unit and disconnects at least one energy consuming component of the machine commensurate with the status signal.

3. The device of claim 2, further comprising a configuration interface configured to specify the at least one energy consuming component to be disconnected.

4. The device of claim 1, wherein an activatable condition in a particular energy profile is considered as being fulfilled when a duration, during which all other activated conditions of the particular energy profile are continuously fulfilled, is equal to or exceeds a limit value.

5. The device of claim 1, wherein the machine is a machine selected from the group of machine tool, production machine and robot.

6. A machine in automation engineering having a device for reducing energy consumption, said device comprising:
an operating unit comprising a display configured to display energy profiles indicating conditions activatable by an operator of the machine, and
a monitoring unit receiving the energy profiles from the operating unit and monitoring the fulfillment of activated conditions and generating for each of the energy profiles a status signal, when all activated conditions of an energy profile are fulfilled.

7. A method for reducing energy consumption of a machine in automation engineering, comprising the steps of:
reading in activated conditions of at least one energy profile selected from activatable conditions of the at least one energy profile, and
monitoring fulfillment of the activated conditions and generating for each of the at least one energy profile a status signal, when all activated conditions of the at least one energy profile are fulfilled.

8. A computer program for reducing energy consumption of a machine in automation engineering, the computer program comprising a program code embodied in a non-transitory medium, wherein the computer program when executed on a computer of the machine causes the machine to read in activated conditions of at least one energy profile selected from activatable conditions of the at least one energy profile, and monitor fulfillment of the activated conditions and generate for each of the at least one energy profile a status signal, when all activated conditions of the at least one energy profile are fulfilled.
